(19) United States
(12) Patent Application Publication
(10) Pub. No.: US 2024/0246270 A1
(43) Pub. Date: Jul. 25, 2024

(54) PLASTIC COMPONENT AND METHOD OF PRODUCTION THEREOF

(71) Applicant: R. STAHL SCHALTGERÄTE GMBH, Waldenburg (DE)

(72) Inventors: Nadine HIRSCH, Untermünkheim (DE); Holger SEMRAU, Satteldorf (DE)

(21) Appl. No.: 18/575,524

(22) PCT Filed: Jun. 1, 2022
(86) PCT No.: PCT/EP2022/064955

§ 371 Date: Dec. 29, 2023

(30) Foreign Application Priority Data
Jul. 1, 2021 (DE) 10 2021 116 975.5

(51) Int. Cl. B29C 45/00; B29C 45/58; B29K 101/12; B29K 105/00; B29L 31/34

(52) U.S. Cl. CPC B29C 45/0053; B29C 45/58; B29K 2101/12; B29K 2105/0026; B29L 2031/3481

(57) ABSTRACT

The method according to the present disclosure provides a plastic housing or other plastic component also according to the present disclosure, wherein the plastic contains a flame retardant, preferably red phosphorus. According to the present disclosure, near-surface regions of the plastic housing or of the rest of the component are depleted of phosphorus. This measure, without impairment of the flame retardancy of the phosphorus used as flame retardant, achieves inertization of the plastic surface in that the plastic surface no longer corrosively attacks adjacent metal components and especially electrical or electronic components.

### CROSS REFERENCE TO RELATED APPLICATIONS

This application is a National Stage of PCT Application No. PCT/EP2022/064955 filed on Jun. 1, 2022, which claims priority to German Patent Application No. 10 2021 116 975.5 filed on Jul. 1, 2021, the contents each of which are incorporated herein by reference thereto.

### TECHNICAL FIELD

The present disclosure refers to a method for production of plastic components, particularly plastic housings, particularly for placing electrical or electronic components therein.

### BACKGROUND

In the plastic material technique it is known to link plastic materials with flame retardants in order to comply with specific fire protection requirements. Elemental red phosphorus or also phosphorus compounds can be used as flame retardant. DE 10 2009 059 771 A1 looks at the consequences of the flame retardant on the plastic material quality. WO 2013/03870584 A1 explains the behavior of such plastic bodies in case of subsequent storage at room temperature. The hydrolysis resistance of plastic materials containing phosphorus consistently plays a certain role. For this purpose, reference is made to DE 10 2007 061 761 A1, DE 10 2007 061 762 A1, DE 10 2008 062 903 A1, WO 2014/086830 A1, WO 2014/086832 A1 and WO 2014/086944 A1. The application of phosphorus containing plastic materials for housings that can also contain electrical or electronic components is apparent from EP 0 768 336 B1, DE 199 20 276 A1 as well as DE 10 2010 041 388 A1. DE 199 20 276 A1 further discusses that phosphorus containing plastic materials can have a detrimental influence on copper.

### BRIEF SUMMARY

Starting therefrom it is the object of the present disclosure to provide a concept for use of flame retarding plastic materials or plastic components, particularly for construction of housings, which can contain electrical or electronic components.

Disclosed is a method for production of a plastic component configured for placement of electrical or electronic components therein, including: providing a plastic material mass and providing a flame retardant as well as mixing of the plastic material mass with the flame retardant, forming of the plastic component, and mobilizing and removing of superficially bound flame retardant from the plastic component.

The method according to the present disclosure starts with a plastic material mass that has been mixed or is mixed with a flame retardant. The plastic material mass can be provided as shapeless mass in liquid or pasty condition, in solid condition in the form of pellets or as semi-finished product (e.g. as plastic wire or plastic plates). If it is liquid at environmental temperature, it can be transferred into solid condition by mean of chemical solidification. If it has been transferred into liquid or pasty condition due to thermal plasticizing, it can be transferred back into solid condition by means of cooling.

The plastic material mass can already be mixed with a flame retardant or can be mixed as uniformly as possible with a flame retardant prior to its further processing.

The forming of the plastic housing or parts thereof can be carried out in a casting process, e.g. by injection molding. If the plastic material mass is provided as semi-finished product, e.g. in the form of plates, the plastic housing or parts thereof can also be made by forming, e.g. heating and deep drawing. An important process step during the production of the plastic component, e.g. the plastic housing, is then the step of mobilizing and removing of superficially bound flame retardant from the plastic housing or components. Thereby measures are taken by means of which near surface flame retardant diffuses out of the plastic component, e.g. plastic housing or parts thereof to the surface and is removed from there. In doing so, a thin surface layer depleted from flame retardant is created on the plastic component as well as in the plastic housing thereby, which however plays no role or only a very subordinate role with regard to the requirements referring to fire safety.

A plastic component provided in this manner can be arranged continuously in the proximity of electrical or electronic components. A plastic housing provided in this manner is suitable for placing electrical and electronic circuits therein and does not show or barely show detrimental influence on metal parts or other sensitive parts arranged in the housing interior, even in use under adverse conditions. This is particularly advantageous in housings of apparatuses that are used under difficult climate conditions, i.e. at particularly high or particularly low temperatures or changing temperatures as well as at high air humidity. The method according to the present disclosure is particularly advantageous for housings that are subject to conditions in which a high humidity concentration or also condensate formation can occur in the housing interior.

The method according to the present disclosure is suitable for production of plastic components and plastic housings in which the flame retardant is red phosphorus or a phosphorus compound. The use of red phosphorus as flame retardant is very economic. In addition, the impacts of phosphorus on the physical characteristics of the plastic material is remarkably less compared with other flame retardants for most of the usable plastic materials. Due to the mobilization and removal of near surface-bound flame retardant according to the present disclosure—particularly phosphorus—it is achieved that in the plastic housing, at least near the surface, only phosphorus remains, which is very well bound into the matrix of the plastic material.

The plastic material can be a thermoset plastic material (cast resin, polyester resin, polyurethane or the like) or a thermoplastic plastic material (Polystyrene (HIPS), Polybutylene terephthalate (PBT), Polyamide (PA6, PA66, PA12 or the like). Preferably, the mobilization and removal of near surface or near surface-bound flame retardant results in that the surface concentration of phosphorus in the completed housing is below 3%, preferably below 2.5%. Surface concentrations of 1.5% up to 2% can be tolerated.

These values can be achieved with a plastic material mass that comprise a phosphorus content prior to forming the housing parts of preferably minimum 8%, thereby however maximum 15%, preferably maximum 12%. The housing produced by means of the method can have a wall thickness of 2-12 mm.

For mobilization and removal of phosphorus from the surface as well as from near surface layers of the plastic housing or of parts of the plastic housing, the housing or the parts are preferably stored at a temperature above 80° C., further preferably above 90° C. Preferably the storage is carried out in an atmosphere having a relative humidity of over 90%, preferably over 95%. Under these conditions near surface phosphorus, which is not firmly bound in the plastic material matrix, moves toward the plastic surface and is oxidized there into phosphoric acid. Forming phosphane or phosphinic acid pass as aerosol or also by direct evaporation into the atmosphere and are removed. For supporting this process, the warm and humid atmosphere in which the plastic housing or the part is stored can also be moved. The reaction products of the phosphorus can thus be transported away from the housing surface and can be captured in a technical device, i.e. a filter, a condensate trap or other devices. If such housing parts or other components are later provided for their use, a remaining concentration of available phosphorus is lowered so that the technical function of the installations, particularly electronic or electrical installations, is not affected.

The present disclosure is directed to the method for production of plastic components, particularly plastic housings or their parts, as well as to the housings or parts produced by means of this method. Such a plastic component, particularly housing, is characterized in that its plastic comprises a phosphorus concentration on the surface that is less than 2.5% by weight, while it comprises in the core, for example in the component center (e.g. wall center) a remarkably higher phosphorus concentration of, for example over 8% by weight. The near surface phosphorus depleted layer can be thin, e.g. thinner than 1 mm. The fire protection characteristics of the plastic housing are thus far not affected.

### BRIEF DESCRIPTION OF THE DRAWINGS

Further aspects of the present disclosure are subject matter of the description as well as the associated drawing and the dependent claims. The drawing shows:

FIG. 1 a progress of a method according to the present disclosure in schematic illustration,

FIG. 2 a housing according to the present disclosure in schematic perspective illustration,

FIG. 3 a wall section of the housing according to FIG. 2 in sectional illustration,

FIG. 4 a diagram for illustration of the phosphorus concentration inside the wall according to FIG. 3 and

FIG. 5 a diagram for illustration of the phosphorus degassing in the method according to FIG. 1.

### DETAILED DESCRIPTION

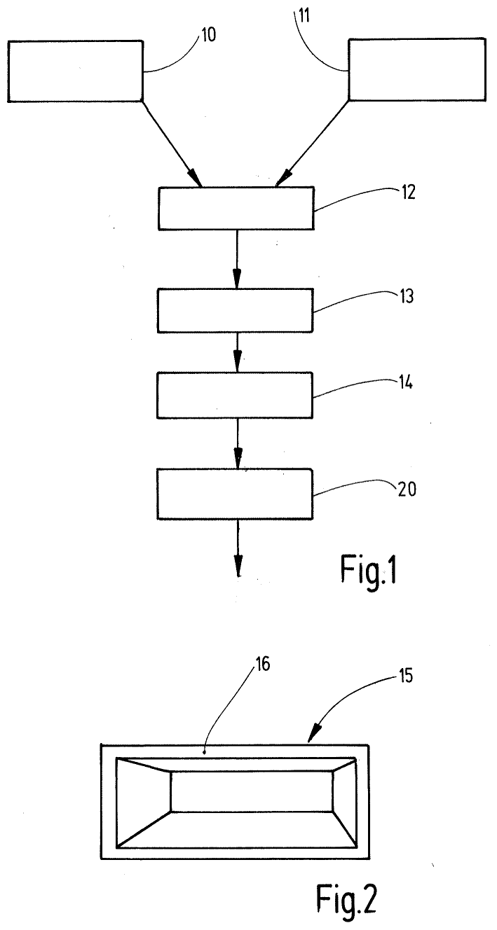

FIG. 1 is the method for providing of plastic housings or other plastic components illustrated as flow diagram. The method starts in providing of plastic material mass (block 10) and providing of a flame retardant, e.g. phosphorus (block 11). The plastic material can be provided as shapeless mass, for example. It can be a polystyrene, a polybutylene terephthalate or polyamide or another thermoplastic plastic material. The flame retardant provided in block 11 is preferably a phosphorus compound or elemental phosphorus (red phosphorus).

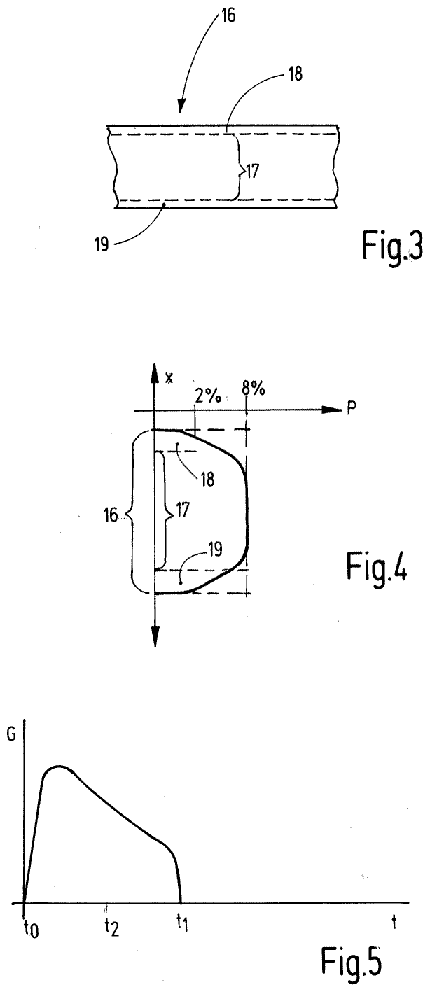

In the next method step the plastic material and the phosphorus or the other flame retardant are mixed uniformly as far as possible and are provided for the further processing, e.g. in form of pellets or also in liquid or pasty shape. If the plastic material mixed with the flame retardant (particularly phosphorus) is present after mixing with the phosphorus in form of pellets, it is plasticized in the next method step (block 13). Then it is injected into an injection mold in block 14. After cooling the so produced plastic component is removed from the mold. In this condition the produced plastic component, e.g. housing part or housing, has its desired final shape. A respective housing 15 is illustrated in FIG. 2 in symbolic manner. Its housing wall 16 is shown in FIG. 3 in sectional and enlarged manner. It comprises a core region 17 and near surface regions 18, 19. The chemical composition of the housing wall 16 is in this stage largely identical in the near surface regions 18, 19 and the core region 17.

This plastic housing 15 or other plastic component is now chemically modified in the near surface regions 18, 19. For this purpose, phosphorus (or other flame retardant) is removed from the near surface regions 18, 19 in block 20. FIG. 4 illustrates for this purpose the content of phosphorus P inside housing wall 16 prior to the step of the removal of phosphorus in dashed line form. As apparent, the housing wall 16 there comprises in the near surface regions 18, 19 as well as in the core region 17 a high phosphorus content of 8% or above.

For removal of phosphorus from the near surface regions 18 and/or 19, housing 15 is subject to a treatment in an atmosphere having a temperature of preferably above 80° C. at a relative humidity above 90%, preferably 95% and in the ideal case of 100%. For example, this method step can be carried out inside a vessel with pure wet steam. Wet steam means steam that is in contact with a water surface and is in thermal balance. The saturated steam or wet steam can be under normal pressure. Then it has a temperature of approximately 100° C. In case of slightly reduced pressure, also lower temperatures can be set. Alternatively, instead of a treatment with saturated steam, also a treatment with a gas atmosphere (nitrogen, oxygen or air), which is saturated with water steam, i.e. comprises a relative humidity of 95% to 100%.

FIG. 5 illustrates the rate G by means of which the phosphorus P leaves the surface of housing wall 16. Shortly after start of the treatment at the point in time t₀ the housing 15 starts to heat and phosphorus increasingly exits from the surface of housing 5. During the storage time t₁ then with increasing depletion of the near surface regions 18, 19, the degassing reduces and practically drops down to zero at the end of the treatment duration t₁ during cooling of housing 15. The storage duration from t₀ to t₁ is at least as long, so that also the core region 17 has been heated to the temperature of the surrounding atmosphere, e.g. 80° C. or 90° C. In this condition the phosphorus concentration inside the wall 16 follows the curve according to FIG. 4. The storage with increased temperature and humidity can be terminated, if phosphorus content in the near surface wall regions 18, 19 has been remarkably lowered, e.g. to a value on the surface of 2% to 2.5%. In the core region it is not lowered or lowered only slightly. The storage duration from t₀ to t₁ is determined depending on the plastic material type, the initial phosphorus concentration, the storage temperature and the humidity during storage, so that this condition occurs.

The plastic housing 15 treated in this manner can now be further used, e.g. equipped with electrical or electronic components and can go into use. A corrosion of the contained components enclosed by the plastic housing 15 and a relevant damage of electrical or electronic components is not to be feared. This also applies, if the plastic housing 15 is used under adverse climate conditions, e.g. in engine rooms, under tropical conditions, under conditions with varying temperatures or in wet environment.

By means of the method according to the present disclosure, a plastic housing or other plastic component according to the present disclosure is provided, a plastic material of which contains a flame retardant, preferably red phosphorus. According to the present disclosure, near surface regions of the plastic housing 15 or the other component are depleted of phosphorus. Due to this measure, without impairment of the flame retardancy of the phosphorus used as flame retardant, an inertization of the plastic surface is achieved in that it no longer causes corrosive attack on neighboring metal parts and in particular electrical or electronic components.

### REFERENCE SIGNS

10 block “providing plastic material”
11 block “providing phosphorus”
12 block “mixing of plastic material and phosphorus”
13 block “plasticizing the plastic material”
14 block “injection molding of the plastic housing”
15 plastic housing
16 housing wall
17 core region
18, 19 near surface region
20 block “removing of phosphorus”

1. A method for production of a plastic component configured for placement of electrical or electronic components therein, comprising:
providing a plastic material mass and providing a flame retardant as well as mixing of the plastic material mass with the flame retardant,
forming of the plastic component, and
mobilizing and removing of superficially bound flame retardant from the plastic component.

2. The method according to claim 1, wherein the flame retardant is red phosphorus or a phosphorus compound.

3. The method according to claim 1, wherein the plastic material mass is a thermoplastic plastic material.

4. The method according to claim 1, wherein a content of the flame retardant is at least 5% by weight of a mixture of the plastic material mass and the flame retardant.

5. The method according to claim 1, wherein a content of the flame retardant is at most 15% by weight of a mixture of the plastic material mass and the flame retardant.

6. The method according to claim 1, wherein the forming step is an injection molding method.

7. The method according to claim 1, wherein the mobilizing and removing of the superficially bound flame retardant is carried out by means of storage of the plastic component at a temperature above 80° C.

8. The method according to claim 1, wherein the mobilizing and removing of the superficially bound flame retardant is carried out by means of storage of the plastic component at a temperature above 90° C.

9. The method according to claim 1, wherein the mobilizing and removing of the superficially bound flame retardant is carried out by means of storage of the plastic component and at a relative humidity of above 90%.

10. The method according to claim 1, wherein the mobilizing and removing of the superficially bound flame retardant is carried out by means of storage of the plastic component at a relative humidity of over 95%.

11. A plastic component manufactured according to the method of claim 1.

12. The plastic component according to claim 11, wherein the plastic component comprises a core region in which a content of the flame retardant, at least at one position, is larger than 8% by weight and wherein the plastic component comprises near surface wall regions covering the entire surface, which have a content of the flame retardant on the surface of less than 2.5% by weight.

13. The plastic component according to claim 11, wherein the plastic component is a housing.

14. The method according to claim 1, wherein the plastic component is a housing.

15. The method according to claim 4, wherein the content of the flame retardant is at least 8% by weight of the mixture of the plastic material mass and the flame retardant.

16. The method according to claim 5, wherein the content of the flame retardant is at most 12% by weight of the mixture of the plastic material mass and the flame retardant.

17. The method according to claim 2, wherein the plastic material mass is a thermoplastic plastic material.

18. The method according to claim 17, wherein a content of the flame retardant is at least 5% by weight of a mixture of the plastic material mass and the flame retardant.

19. The method according to claim 18, wherein a content of the flame retardant is at most 15% by weight of a mixture of the plastic material mass and the flame retardant.

20. The method according to claim 19, wherein the forming step is an injection molding method.
